(19) United States
(12) Patent Application Publication
(10) Pub. No.: US 2013/0154421 A1
(43) Pub. Date: Jun. 20, 2013

(54) SPINDLE MOTOR

(71) Applicant: SAMSUNG ELECTRO-MECHANICS CO., LTD., Suwon (KR)

(72) Inventor: Sung Bu Jo, Suwon (KR)

(73) Assignee: SAMSUNG ELECTRO-MECHANICS CO., LTD., Suwon (KR)

(21) Appl. No.: 13/720,484

(22) Filed: Dec. 19, 2012

(30) Foreign Application Priority Data
Dec. 20, 2011 (KR) 10-2011-0138277

(51) Int. Cl. H02K 7/08

(52) U.S. Cl. CPC H02K 7/088
USPC 310/90

(57) ABSTRACT

Disclosed herein is a spindle motor in which a corresponding surface of a cover member that an operating fluid circulated from a radial bearing part of the spindle motor contacts is formed to be tapered. A taper part is formed on the corresponding surface of the cover member that the operating fluid forming a fluid dynamic pressure bearing is circulated to contact to improve durability of the cover member and increase a circulation speed of the operating fluid, thereby making it possible to improve current characteristics.

### CROSS REFERENCE TO RELATED APPLICATION

This application claims the benefit of Korean Patent Application No. 10-2011-0138277, filed on Dec. 20, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, a spindle motor including a fluid dynamic pressure bearing having lower driving friction as compared to an existing ball bearing has generally been used in order to minimize generation of noise and non repeatable run out (NRRO), which is vibration generated at the time of use of a ball bearing. In the fluid dynamic pressure bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic pressure bearing, lubricating oil (hereinafter, referred to as ‘operating fluid) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in that the shaft is supported by a shaft ball made of iron.

When the fluid dynamic pressure bearing is used in the spindle motor, the rotor is supported by the fluid, such that a noise amount generated in the motor is small, power consumption is low, and impact resistance is excellent.

FIG. 1 is a table showing a deformation degree according to a motor driving time in a structure of a cover member according to the prior art. In FIG. 1, a unit of a deformed numerical value is micrometer (μm). According to the prior art, the spindle motor using the fluid dynamic pressure bearing includes a cover member coupled to a lower portion thereof in an axial direction so as to store an operating fluid. The operating fluid provided in a radial dynamic pressure bearing formed in a coupled surface between a shaft and a sleeve flows down to the cover member in order to circulate a bearing part. In this configuration, a portion on the cover member that the operating fluid flows down to contact is continuously applied with force, such that durability thereof is easily weakened. As in Table shown in FIG. 1, in a motor rotating at 10000 RPMs, deformation of 4.54 to 7.5 μm based on five minutes occurs. As in results in each time unit for each of eight samples, in the case in which the motor rotates at a high speed, a corresponding cover member surface is deformed according to continuous circulation of the operating fluid, thereby hindering smooth circulation of the operating fluid.

Particularly, in the case in which force by the operating fluid is continuously applied to the cover member, the cover member is deformed, and the operating fluid forming the fluid dynamic pressure bearing does not smoothly flow due to deformation of the cover member. In the spindle motor using the fluid dynamic pressure bearing, in the case in which the operating fluid is not smoothly circulated, a serious problem such as deterioration of operation performance and reliability of the motor is generated.

### SUMMARY OF THE INVENTION

The present invention has been made in an effort to provide a spindle motor in which a taper part is formed on a corresponding surface of an inner side of a cover member that an operating fluid forming a fluid dynamic pressure bearing continuously contacts due to circulation of the operating fluid in order to smoothly circulate the operating fluid, such that durability of the cover member is improved, and operation performance and reliability of the motor are improved through the smooth circulation of the operating fluid.

According to a preferred embodiment of the present invention, there is provided a spindle motor including: a shaft becoming the rotation center of a rotor; a sleeve receiving the shaft therein and rotatably supporting the shaft; and a cover member coupled so as to cover lower ends of the shaft and the sleeve in an axial direction, wherein the cover member includes a taper part formed on a corresponding surface thereof that an operating fluid of a radial dynamic pressure bearing part formed in a coupled surface between the shaft and the sleeve flows downwardly in the axial direction to contact.

The cover member may be manufactured by press processing.

The taper part may be formed to be inclined in a direction toward an outer edge of the cover member.

The taper part formed on the cover member may be formed to be bent in the range of an angle less than 45 degrees downwardly in the axial direction in a direction toward an outer edge of the cover member.

The spindle motor may further include a base coupled to an outer side surface of the sleeve so as to support the sleeve and having a core mounted on an inner side surface thereof, the core having a coil wound therearound; and a hub having the shaft coupled integrally therewith at a central portion thereof and having a rotor magnet formed at a position thereof corresponding to the core.

According to a second preferred embodiment of the present invention, there is provided a spindle motor including: a shaft becoming the rotation center of a rotor; a sleeve receiving the shaft therein and rotatably supporting the shaft; and a cover member coupled so as to cover lower ends of the shaft and the sleeve in an axial direction, wherein the cover member includes a first bent part formed on a corresponding surface thereof that an operating fluid of a radial dynamic pressure bearing part formed in a coupled surface between the shaft and the sleeve flows downwardly in the axial direction to contact and a second bent part spaced apart from the first bent part in a direction toward an outer edge of the cover member and bent inwardly of the cover member.

The cover member may be manufactured by press processing.

The first bent part may be formed to be bent downwardly in the axial direction in the direction toward the outer edge of the cover member, and the second bent part may be spaced apart from the first bent part in the direction toward the outer edge of the cover member and is bent inwardly of the cover member.

The first bent part formed on the cover member may be formed to be bent in the range of an angle less than 45 degrees downwardly in the axial direction in the direction toward the outer edge of the cover member, and the second bent part may be formed to be bent in the range of an angle less than 45 degrees upwardly in the axial direction inwardly of the cover member.

The spindle motor may further include a base coupled to an outer side surface of the sleeve so as to support the sleeve and having a core mounted on an inner side surface thereof, the core having a coil wound therearound; and a hub having the shaft coupled integrally therewith at a central portion thereof and having a rotor magnet formed at a position thereof corresponding to the core.

### BRIEF DESCRIPTION OF THE DRAWINGS

FIG. 1 is a table showing a deformation degree according to a motor driving time in a structure of a cover member according to the prior art;

FIG. 2 is a partial cross-sectional view of a spindle motor including a cover member according to a first preferred embodiment of the present invention;

FIG. 3 is a partial cross-sectional view of a spindle motor including a cover member according to a second preferred embodiment of the present invention; and

FIG. 4 is a cross-sectional view of the spindle motor according to the first preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In addition, an “axial direction” used in the preset invention refers to a length direction in which a shaft becoming a rotation axis is formed, and an “upper portion and a “lower portion” in the axial direction are based on length-wise upper and lower portions of a shaft shown in FIG. 4. In describing the present invention, a detailed description of related known functions or configurations will be omitted so as not to obscure the gist of the present invention.

Hereinafter, preferred embodiments of the present invention will be described in detail with reference to the accompanying drawings.

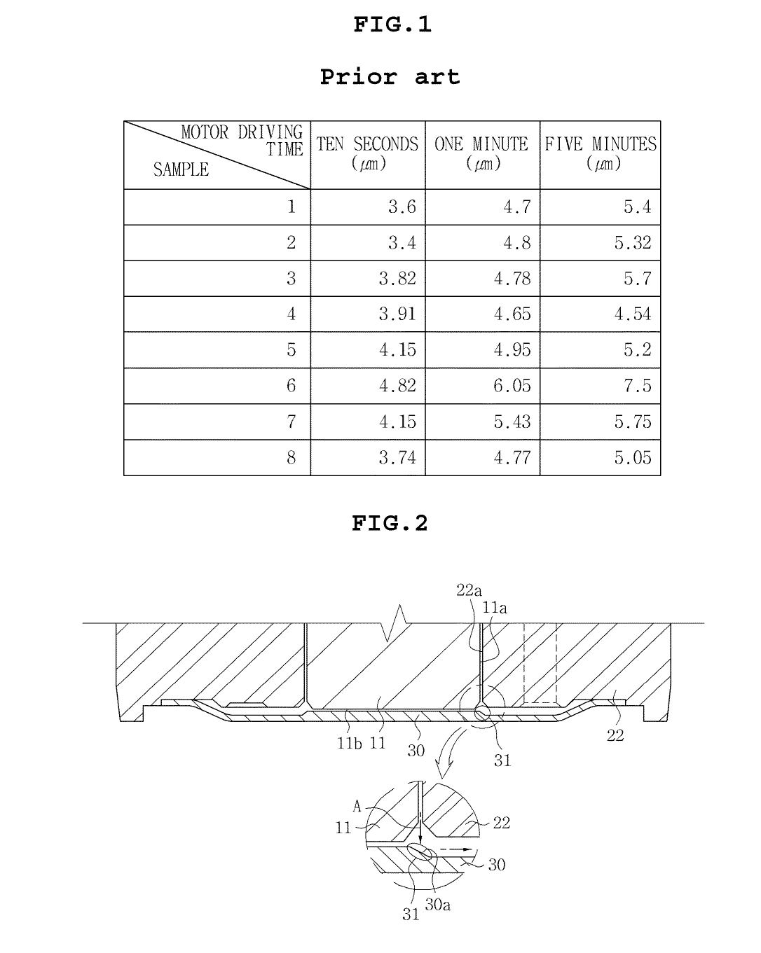

FIG. 2 is a partial cross-sectional view of a spindle motor including a cover member according to a first preferred embodiment of the present invention.

The spindle motor according to the first preferred embodiment of the present invention includes a shaft 11 becoming the rotation center of a rotor, a sleeve 22 receiving the shaft 11 therein and rotatably supporting the shaft 11, and a cover member 30 coupled so as to cover lower ends of the shaft 11 and the sleeve 22 in the axial direction, wherein the cover member 30 includes a taper part 31 formed on a corresponding surface 30a thereof that an operating fluid of a radial dynamic pressure bearing part 50 formed in a coupled surface between the shaft 11 and the sleeve 22 flows downwardly in the axial direction to contact.

The shaft 11 becomes the center axis around which the spindle motor rotates and has generally a cylindrical shape. A thrust plate 40 for forming a thrust dynamic pressure bearing part by a fluid dynamic pressure bearing may be insertedly installed so as to be orthogonal to an upper side portion of the shaft 11. Here, the thrust plate 40 may be formed at the upper side portion of the shaft 11 or be insertedly installed so as to orthogonal to a lower end portion of the shaft 11. In order to fix the thrust plate 40 to the shaft 11, separate laser welding, or the like, may be used. However, it is obvious to those skilled in the art that the thrust plate 40 may be press-fitted into and coupled to the shaft 11 by being applied with a predetermined pressure. The thrust plate 40 may include a dynamic pressure generation groove (not shown) formed therein in order to form the thrust dynamic pressure bearing part by the fluid dynamic pressure bearing.

The sleeve 22 may have a hollow cylindrical shape so as to receive the shaft 11 therein and rotatably support the shaft 11, and the radial dynamic pressure bearing part 50 by oil, which is the operating fluid, may be formed in an outer peripheral surface 11a of the shaft 11 and an inner peripheral surface 22a of the sleeve 22 coupled to each other. In addition, a dynamic pressure generation groove (not shown) for dynamic pressure generation of the radial dynamic pressure bearing part 50 may be formed in the outer peripheral surface 11a of the shaft 11 or the inner peripheral surface 22a of the sleeve 22 in which the radial dynamic pressure bearing part 50 is formed.

The cover member 30 is coupled in order to cover a lower end surface of the sleeve 22 including the shaft 11. The cover member 30 includes a dynamic pressure generation groove (not shown) formed in an inner side surface thereof facing the lower end surface 11b of the shaft 11, thereby making it possible to form a thrust dynamic pressure bearing part. The cover member 30 may have a structure in which it is coupled to a distal end of the sleeve 22, such that the oil, which is the operating fluid, may be stored therein.

Particularly, the present invention is to solve a problem that durability of a central portion of the cover member 30 is deteriorated due to force transferred to the corresponding surface 30a of the cover member 30 through continuous circulation of the operating fluid provided in the radial dynamic pressure bearing part 50. As shown in FIG. 2, the operating fluid flows down from the radial dynamic pressure bearing part 50 formed in the coupled surface between the shaft 11 and the sleeve 22 in an A direction, which is a direction toward a lower portion in the axial direction. Since the operating fluid is continuously circulated by driving of the motor, the corresponding surface 30a of the cover member 30 is continuously applied with force at which the operating fluid drops to the lower portion in the axial direction. When the cover member 30 is continuously applied with the force as described above, the cover member 30 is deformed, and the operating fluid may not be smoothly circulated due to the deformation of the cover member 30. More specifically, a thickness or a bending deformation degree of the central portion of the cover member 30 is changed by the force that the operating fluid continuously transfers to the corresponding surface 30a of the cover member 30. For example, in the case in which the cover member 30 has a thickness of 15 μm, deformation of about 1 to 2 μm occurs in the cover member 30 when the motor is driven for five minutes, and in the case in which the cover member 30 has a thickness of 10 μm, deformation of about 3 to 4 μm occurs in the cover member 30 when the motor is driven for five minutes. In addition, as described above, it may be appreciated from data on the samples shown in FIG. 1 that deformation of 4.54 to 7.5 μm occurs in the cover member 30 when the motor is driven for five minutes. The deformation as described above occurs in the corresponding surface 30a of the cover member 30 applied with the force by the operating fluid due to the circulation of the operating fluid, such that smooth circulation of the operating fluid forming the fluid dynamic pressure bearing becomes difficult, thereby deteriorating reliability of the motor operation.

Therefore, according to the preferred embodiment, the taper part 31 is formed on the corresponding surface 30a of the cover member 30 to which the force is transferred since the operating fluid continuously flows down from the radial dynamic pressure bearing part 50 in the A direction. When the operating fluid flows down in the A direction to apply the force to the corresponding surface 30a of the cover member 30, a taper is provided on the corresponding surface 30a of the cover member 30, thereby making it possible to reduce load transferred from the operating fluid to the corresponding surface 30a of the cover member 30. The taper part 31 is formed on the corresponding surface 30a of the cover member 30, such that smaller load is transferred to the corresponding surface 30a of the cover member 30 than force transferred to the corresponding surface 30a of the cover member 30 in the case in which the corresponding surface 30a of the cover member 30 is formed to be perpendicular to the A direction in which the operating fluid flows down. Particularly, the taper part 31 is formed to be inclined outwardly of the cover member 30 to increase a circulation speed of the operating fluid, thereby making it possible to improve current characteristics according to the motor driving. In addition, a flow speed of the operating fluid increases, thereby making it possible to implement a higher revolutions per minute (RPM).

In addition, the taper part 31 formed on the cover member 30 may be easily manufactured by press processing. The taper part 31 is manufactured by the press processing to reduce a lead time according to production of products, thereby making it possible to improve productivity of the products.

In addition, the taper part 31 formed on the cover member 30 may be formed to be inclined in the range of an angle less than 45 degrees downwardly in the axial direction in a direction toward an outer edge of the cover member 30. When an inclination angle of the taper part 31 is excessively large, since an angle formed by the A direction, which is a direction in which the operating fluid applies the force, and the corresponding surface 30a, is almost perpendicular, an effect of reducing the force transferred to the cover member 30 may be deteriorated. However, the inclination angle of the taper part 31 may be selected and applied by those skilled in the art as long as it is in a range of an angle less than 90 degrees.

In addition, the spindle motor according to the first preferred embodiment of the present invention further includes a base 21 coupled to an outer side surface of the sleeve 22 so as to support the sleeve 22 and having a core 23 mounted on an inner side surface thereof, the core 23 having a coil 23a wound therearound; and a hub 12 having the shaft 11 coupled integrally therewith at a central portion thereof and having a rotor magnet 13 formed at a position thereof corresponding to the core 23.

The base 21 has one side surface coupled to the outer side surface of the sleeve 22 so that the sleeve 22 including the shaft 11 is coupled to an inner side thereof. The base 21 has the core 23 coupled to the other side surface thereof, which is an opposite side to one side surface thereof, at a position corresponding to that of the rotor magnet 13 formed on the hub 12, wherein the core 23 has a winding coil wound therearound. The base 21 may serve to support the entire structure of the spindle motor at a lower portion of the spindle motor and be manufactured by press processing or die-casting. In the case in which the base 21 is manufactured by the press processing, the base 21 may be made of various metal materials such as aluminum, steel, and the like, particularly, a material having rigidity. The base 21 and the sleeve 22 may be assembled to each other by applying an adhesive to an inner surface of the base 21 or an outer surface of the sleeve 22. A conductive adhesive (not shown) for conduction between the base 21 and the sleeve 22 may be connected to and formed on a lower end surface of a portion at which the base 21 and the sleeve 22 are bonded to each other. The conductive adhesive is formed to allow excessive charges generated at the time of operation of the motor to flow out through the base 21, thereby making it possible to improve reliability of the operation of the motor.

The core 23 is generally formed by stacking a plurality of thin metal plates and is fixedly disposed on the base 21 including a flexible printed circuit board 60. A plurality of through-holes 21a may be formed in a lower end surface of the base 21 so as to correspond to the coil 23a led from the winding coil 23a, and the coil 23a led through the through-holes 21a may be soldered and electrically connected to the flexible printed circuit board 60. An insulating sheet 21b may be formed at an inlet portion of the through-hole 21a in order to insulate the through-hole 21a and the coil 23a passing through the through-hole 21a from each other.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in the axial direction. The rotor magnet 13 is formed so as to correspond to the core 23 of the base 21 in a radial direction. The core 23 generates a magnetic flux while forming a magnetic flux when current flows. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

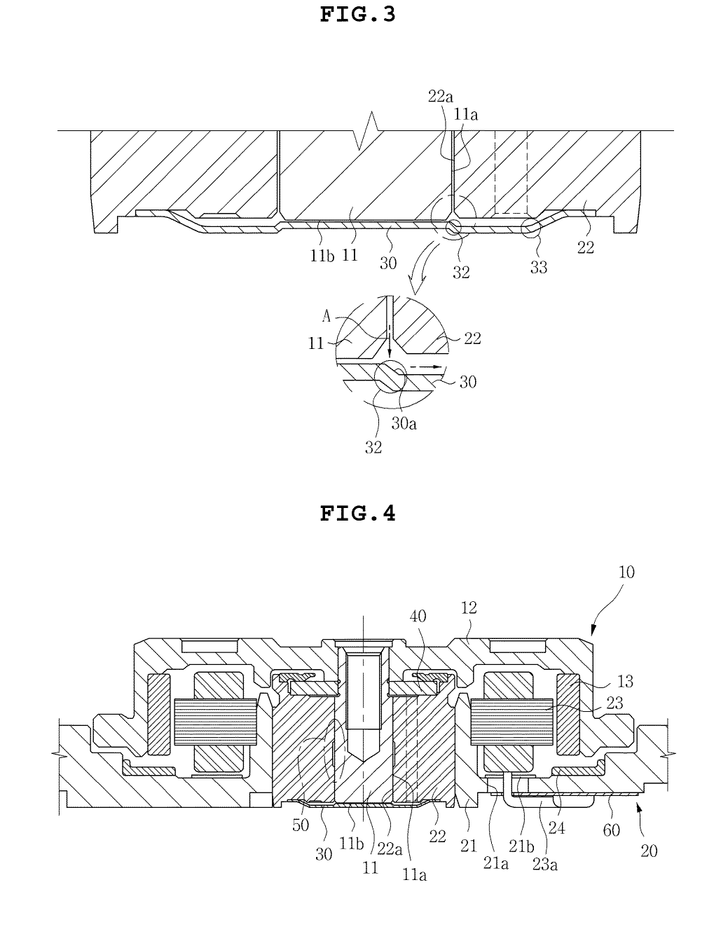

FIG. 3 is a partial cross-sectional view of a spindle motor including a cover member 30 according to a second preferred embodiment of the present invention.

The spindle motor according to the second preferred embodiment of the present invention includes a shaft 11 becoming the rotation center of a rotor, a sleeve 22 receiving the shaft 11 therein and rotatably supporting the shaft 11, and a cover member coupled 30 so as to cover lower ends of the shaft 11 and the sleeve 22 in the axial direction, wherein the cover member 30 includes a first bent part 32 formed on a corresponding surface 30a thereof that an operating fluid of a radial dynamic pressure bearing part 50 formed in a coupled surface between the shaft 11 and the sleeve 22 flows downwardly in the axial direction to contact and a second bent part 33 spaced apart from the first bent part 32 in a direction toward an outer edge of the cover member 30 and bent inwardly of the cover member 30.

Unlike the first preferred embodiment of the present invention described above, according to the second preferred embodiment of the present invention, the cover member 30 itself corresponding to the corresponding surface 30a of the cover member 30 that the operating fluid flowing from the radial dynamic pressure bearing part 50 downwardly in the axial direction to thereby be circulated contacts is bent to form the first bent part 32, thereby making it possible to smoothly circulate the operating fluid and improve rigidity of the cover member 30 together with the second bent part 33 of the outer edge of the cover member 30. Since a detailed description of each of other configurations is overlapped with that of the first preferred embodiment of the present invention, it will be omitted below.

The shaft 11 becomes the center axis around which the spindle motor rotates and has generally a cylindrical shape. A thrust plate 40 for forming a thrust dynamic pressure bearing part by a fluid dynamic pressure bearing may be insertedly installed so as to orthogonal to an upper side portion of the shaft 11.

The sleeve 22 may have a hollow cylindrical shape so as to receive the shaft 11 therein and rotatably support the shaft 11, and the radial dynamic pressure bearing part 50 by oil, which is the operating fluid, may be formed in an outer peripheral surface 11a of the shaft 11 and an inner peripheral surface 22a of the sleeve 22 coupled to each other.

The cover member 30 may have a structure in which it is coupled to cover a lower end surface of the sleeve 22 including the shaft 11, such that the oil, which is the operating fluid, may be stored in an inner portion of a distal end of the sleeve 22.

According to the second preferred embodiment of the present invention, the first bent part 32 is formed on the inner side surface of the cover member 30 that the operating fluid of the radial dynamic pressure bearing part 50 formed in the coupled surface between the shaft 11 and the sleeve 22 flows downwardly in the axial direction to contact, and the second bent part 33 spaced apart from the first bent part 32 in the direction toward the outer edge of the cover member 30 and bent inwardly of the cover member 30 is formed.

The first bent part 32 is formed to be bent downwardly in the axial direction in the direction toward the outer edge of the cover member 30. The first bent part 32 is formed to be bent downwardly in the axial direction, such that the operating fluid may be circulated at a faster speed on the corresponding surface 30a of the cover member 30 on which the first bent part 32 is formed. In this case, the first bent part 32 may be bent downwardly in the axial direction in the direction toward the outer edge of the cover member 30 in a range of an angle less than 45 degrees. When the bent angle is excessively large, an effect of reducing the force transferred to the corresponding surface 30a of the cover member 30 may not be accomplished. However, according to the preferred embodiment of the present invention, a range of an angle at which the first bent part 32 of the cover member 30 is bent may be changed in design by those skilled in the art in a range of an angle less than 90 degrees.

The second bent part 33 is formed to be spaced apart from the first bent part 32 in the direction toward the outer edge of the cover member 30 and is bent inwardly of the cover member 30, that is, upwardly in the axial direction. The first bent part 32 and the second bent part 33 formed to be spaced apart from the first bent part 32 may implement a structure capable of improving rigidity of the cover member 30 itself. Therefore, it is possible to reduce strength of the force at which the operating fluid circulated from the radial dynamic pressure bearing part 50 is transferred to the corresponding surface 30a of the cover member 30. The second bent part 33 may be bent upwardly in the axial direction in a range of an angle less than 45 degrees, similar to the first bent part 32. In addition, the second bent part 33 is formed to be bent at the same angle as the bent angle of the first bent part 32, thereby making it possible to maintain balanced rigidity through a corresponding structure. However, a corresponding angle of the first and second bent parts 32 and 33 according to the preferred embodiment of the present invention is not limited thereto, but may be a combination of bent angles in various ranges.

In addition, the spindle motor according to the second preferred embodiment of the present invention may further includes a base 21 coupled to an outer side surface of the sleeve 22 so as to support the sleeve 22 and having a core 23 mounted on an inner side surface thereof, the core 23 having a coil 23a wound therearound; and a hub 12 having the shaft 11 coupled integrally therewith at a central portion thereof and having a rotor magnet 13 formed at a position thereof corresponding to the core 23. Since a detailed description thereof is overlapped with a description of a configuration and an action according to the first preferred embodiment of the present invention, it will be omitted below.

FIG. 4 is a cross-sectional view of the spindle motor according to the first preferred embodiment of the present invention.

Components of the spindle motor according to the preferred embodiment of the present invention and an operation relationship therebetween will be briefly described below with reference to FIG. 4.

A rotor 10 includes the shaft 11 becoming a rotation axis and rotatably formed and the hub 12 having the rotor magnet 13 attached thereto, and a stator 20 includes the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 and the rotor magnet 13 have attractive force acting therebetween, thereby making it possible to stably rotate the motor.

Particularly, according to the preferred embodiment of the present invention, a coupling structure of the cover member 30 is changed, thereby making it possible to smoothly circulate the operating fluid of the fluid dynamic pressure bearing at the time of driving of the motor. In addition, the operating fluid is smoothly and more rapidly circulated, thereby making it possible to improve current characteristics and implement higher RPM.

As set forth above, the cover member formed so as to store and circulate the operating fluid of the spindle motor using the fluid dynamic pressure bearing is structurally changed, thereby making it possible to maintain smooth circulation of the operating fluid.

In addition, the taper part is formed on the corresponding surface of the cover member that the operating fluid forming the fluid dynamic pressure bearing is circulated to contact to improve durability of the cover member and increase a circulation speed of the operating fluid, thereby making it possible to improve current characteristics.

Further, the taper part is formed on the corresponding surface of the cover member that the operating fluid forming the fluid dynamic pressure bearing is circulated to contact to smoothly circulate the operating fluid, thereby making it possible to improve the current characteristics and efficiency of the motor operation.

Furthermore, the operating fluid forming the fluid dynamic pressure bearing flows through the taper part of the cover member, thereby making it possible to reduce the force continuously applied from the circulated operating fluid to the corresponding surface of the cover member.

Moreover, two bent parts are formed at both distal ends of the cover member storing the operating fluid, thereby making it possible to secure rigidity of the cover member itself as well as durability of the cover member against the force transferred from the operating fluid.

In addition, the operating fluid forming the fluid dynamic pressure bearing passes through the taper part formed on the cover member, such that a speed thereof increases, thereby making it possible to implement a faster RPM.

Further, the operating fluid forming the fluid dynamic pressure bearing passes through the taper part formed on the cover member, such that the operating fluid is smoothly circulated, thereby making it possible to improve operation performance and driving reliability of the motor.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft becoming the rotation center of a rotor;
a sleeve receiving the shaft therein and rotatably supporting the shaft; and
a cover member coupled so as to cover lower ends of the shaft and the sleeve in an axial direction,
wherein the cover member includes a taper part formed on a corresponding surface thereof that an operating fluid of a radial dynamic pressure bearing part formed in a coupled surface between the shaft and the sleeve flows downwardly in the axial direction to contact.

2. The spindle motor as set forth in claim 1, wherein the cover member is manufactured by press processing.

3. The spindle motor as set forth in claim 1, wherein the taper part is formed to be inclined in a direction toward an outer edge of the cover member.

4. The spindle motor as set forth in claim 1, wherein the taper part formed on the corresponding surface of the cover member is formed to be bent in the range of an angle less than 45 degrees downwardly in the axial direction in a direction toward an outer edge of the cover member.

5. The spindle motor as set forth in claim 1, further comprising:
a base coupled to an outer side surface of the sleeve so as to support the sleeve and having a core mounted on an inner side surface thereof, the core having a coil wound therearound; and
a hub having the shaft coupled integrally therewith at a central portion thereof and having a rotor magnet formed at a position thereof corresponding to the core.

6. A spindle motor comprising:
a shaft becoming the rotation center of a rotor;
a sleeve receiving the shaft therein and rotatably supporting the shaft; and
a cover member coupled so as to cover lower ends of the shaft and the sleeve in an axial direction,
wherein the cover member includes a first bent part formed on a corresponding surface thereof that an operating fluid of a radial dynamic pressure bearing part formed in a coupled surface between the shaft and the sleeve flows downwardly in the axial direction to contact and a second bent part spaced apart from the first bent part in a direction toward an outer edge of the cover member and bent inwardly of the cover member.

7. The spindle motor as set forth in claim 6, wherein the cover member is manufactured by press processing.

8. The spindle motor as set forth in claim 6, wherein the first bent part is formed to be bent downwardly in the axial direction in the direction toward the outer edge of the cover member, and the second bent part is spaced apart from the first bent part in the direction toward the outer edge of the cover member and is bent inwardly of the cover member.

9. The spindle motor as set forth in claim 6, wherein the first bent part formed on the cover member is formed to be bent in the range of an angle less than 45 degrees upwardly in the axial direction in the direction toward the outer edge of the cover member, and the second bent part is formed to be bent in the range of an angle less than 45 degrees downwardly in the axial direction inwardly of the cover member.

10. The spindle motor as set forth in claim 6, comprising:
a base coupled to an outer side surface of the sleeve so as to support the sleeve and having a core mounted on an inner side surface thereof, the core having a coil wound therearound; and
a hub having the shaft coupled integrally therewith at a central portion thereof and having a rotor magnet formed at a position thereof corresponding to the core.
